(19) United States
(12) Patent Application Publication
(10) Pub. No.: US 2026/0245935 A1
(43) Pub. Date: Aug. 20, 2026

(54) OPTIMIZING MEMBRANE ELECTRODE ASSEMBLY CONSTRUCTION TO REDUCE FUEL CROSSOVER AND ENHANCE OPEN CIRCUIT VOLTAGE PERFORMANCE IN PEM FUEL CELLS

(71) Applicant: Honda Motor Co., Ltd., Tokyo (JP)

(72) Inventors: Yiman ZHANG, San Jose, CA (US); Mrittunjoy SARKER, Merced, CA (US); Shutang CHEN, Livermore, CA (US); Gugang CHEN, Palo Alto, CA (US)

(21) Appl. No.: 19/057,556

(22) Filed: Feb. 19, 2025

(51) Int. Cl. H01M 8/1004; H01M 4/86; H01M 4/88; H01M 4/92

(52) U.S. Cl. CPC H01M 8/1004; H01M 4/8828; H01M 4/8882; H01M 4/92; H01M 2004/8684; H01M 2004/8689

(57) ABSTRACT

Aspects of the present disclosure generally relate to methods of preparing membrane electrode assemblies. More specifically, aspects of the present disclosure relate to preparing membrane electrode assemblies having an anode component formed via a rod coating process and a cathode component formed via a spray coating process. In some aspects, a method for preparing a membrane electrode assembly (MEA) includes depositing, by a rod coating process, a first ink composition onto a first surface of a substrate. The method further includes heat treating the substrate to convert the first ink composition to an anode component. The method further includes depositing, by a spray coating process, a second ink composition onto a second surface of the substrate opposite the first surface to form a MEA. The method further includes drying the MEA, wherein the second ink composition is converted to a cathode component.

### FIELD

Aspects of the present disclosure generally relate to methods of preparing membrane electrode assemblies. More specifically, aspects of the present disclosure relate to preparing membrane electrode assemblies having an anode component formed via a rod coating process and a cathode component formed via a spray coating process.

### BACKGROUND

Next-generation fuel cells aim to meet the often-conflicting demands of high performance, low cost, and long life through the use of advanced materials, including catalysts, membranes, and gas diffusion media. The membrane electrode assembly (MEA) is the core of fuel cells and serves as the essential component for evaluating the performance of particular catalysts, ionomers, or membranes. Even when using the same materials, the construction method of the MEA can significantly affect the cell performance, including fuel crossover, open circuit voltage, power density, and operational lifespan. Therefore, optimizing MEA construction is as important as developing advanced materials. Unfortunately, this aspect has not received sufficient attention.

There is a need to develop new construction methods for MEAs to achieve their full potential for practical applications.

### SUMMARY

Aspects of the present disclosure generally relate to methods of preparing membrane electrode assemblies. More specifically, aspects of the present disclosure relate to preparing membrane electrode assemblies having an anode component formed via a rod coating process and a cathode component formed via a spray coating process.

In some aspects, a method for preparing a membrane electrode assembly (MEA) includes depositing, by a rod coating process, a first ink composition onto a first surface of a substrate. The method further includes heat treating the substrate to convert the first ink composition to an anode component. The method further includes depositing, by a spray coating process, a second ink composition onto a second surface of the substrate opposite the first surface to form a MEA. The method further includes drying the MEA, wherein the second ink composition is converted to a cathode component.

In some aspects, membrane electrode assembly (MEA) includes an anode component disposed on a first surface of a substrate. The anode component has a thickness in a range from about 5 μm to about 20 μm, and a platinum loading in a range from about 0.05 mg/cm² to about 0.4 mg/cm². The MEA further includes a cathode component disposed on a second surface of the substrate opposite the first surface of the substrate. The cathode component has a thickness in a range from about 10 μm to about 30 μm, and a platinum loading in a range from about 0.1 mg/cm² to about 0.4 mg/cm². The MEA has a cross-over current of about 0.9 mA/cm² or less, as determined by cyclic voltammetry.

In some aspects, a method for preparing a membrane electrode assembly (MEA) includes depositing, by a rod coating process, a first ink composition onto a first surface of a substrate. The method further includes heat treating the substrate to convert the first ink composition to an anode component. The method further includes depositing, by a spray coating process, a second ink composition onto a second surface of the substrate opposite the first surface to form a MEA. The method further includes drying the MEA to convert the second ink composition to a cathode component. The MEA has a cross-over current of about 0.9 mA/cm² or less, as determined by cyclic voltammetry.

### BRIEF DESCRIPTION OF THE DRAWINGS

So that the manner in which the above recited features of the present disclosure may be understood in detail, a more particular description of the disclosure, briefly summarized above, may be had by reference to aspects, some of which are illustrated in the appended drawings. It is to be noted, however, that the appended drawings illustrate only exemplary aspects and are therefore not to be considered limiting of its scope, for the disclosure may admit to other equally effective aspects.

FIG. 1 is a process flow diagram, according to one or more aspects.

FIG. 2 is a series of scanning electron microscopy images of various membrane electrode assemblies, according to one or more aspects.

FIG. 3 is a graphical illustration of a cyclic voltammetry analysis, according to one or more aspects.

FIG. 4A is a graphical illustration summarizing the electrochemical surface area (ECSA) of various membrane electrode assemblies, according to one or more aspects.

FIG. 4B is a graphical illustration summarizing the mass activity of various membrane electrode assemblies, according to one or more aspects.

FIG. 4C is a graphical illustration summarizing the specific activity of various membrane electrode assemblies, according to one or more aspects.

FIG. 5A is a graphical illustration of polarization curves of various membrane electrode assemblies at 60% relative humidity, according to one or more aspects.

FIG. 5B is a graphical illustration of power density as a function of current density of various membrane electrode assemblies at 60% relative humidity, according to one or more aspects.

FIG. 5C is a graphical illustration of polarization curves of various membrane electrode assemblies at 100% relative humidity, according to one or more aspects.

FIG. 5D is a graphical illustration of power density as a function of current density of various membrane electrode assemblies at 100% relative humidity, according to one or more aspects.

FIG. 6A is a graphical illustration summarizing the cross-over current of various membrane electrode assemblies, according to one or more aspects.

FIG. 6B is a graphical illustration summarizing the open circuit voltage of various membrane electrode assemblies during at a break-in, according to one or more aspects.

FIG. 6C is a graphical illustration summarizing the open circuit voltage of various membrane electrode assemblies at 60% relative humidity, according to one or more aspects.

FIG. 6D is a graphical illustration summarizing the open circuit voltage of various membrane electrode assemblies at 60% relative humidity, according to one or more aspects.

### DETAILED DESCRIPTION

Aspects of the present disclosure generally relate to methods of preparing membrane electrode assemblies (MEAs). More specifically, the method disclosed herein utilizes a rod coating process to form an anode component of an MEA, and a spray coating process to form a cathode component of an MEA. Notably, MEAs fabricated using a rod coated anode component and a spray coated cathode component exhibit enhanced performance over traditionally formed MEAs. Furthermore, the fabrication method disclosed herein is proposed to be able to be effectively applied to various other materials, in addition to commercial catalysts, to achieve significant improvements in MEA performance.

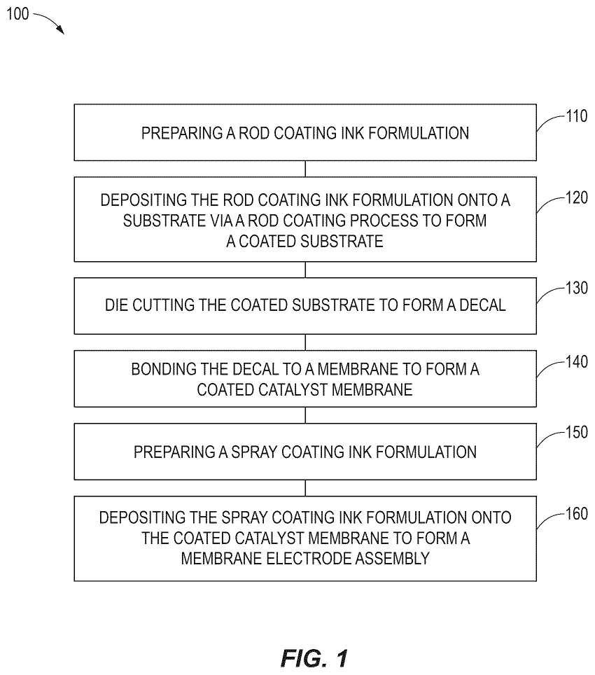

In some aspects, the method of the present disclosure includes preparing a catalyst slurry and preparing an anode component therefrom. In operation 110 of the method 100 shown in FIG. 1, an ink formulation is prepared from a catalyst slurry. The catalyst slurry is often referred to as an “ink” and the terms are used interchangeably herein. The term “mixture,” as used herein, refers to a combination of substances that have been intermingled and is intended to cover either a mixture, a slurry, or a solution. The term “slurry” refers to a mixture where there is some suspended and undissolved material (e.g., particles and/or agglomerates) within a continuous fluid phase, usually a liquid phase, and the liquid in the liquid phase generally being a solvent. The term “solution” refers to a mixture where there is a solute dissolved in a solvent, thereby forming a single phase containing two or more different substances. The catalyst slurry is initially prepared as a solution of a proton conducting polymer, herein referred to as an ionomer (e.g. Nafion®), with suspended particles of electrically conductive material, typically carbon, and particles of catalyst.

The electrically conductive material (e.g., carbon) may be used as the support for the catalyst. The catalyst layer dispersion may include a mixture of a catalyst composition (e.g., catalyst supported on high surface area carbon support) and an ionomer solution (e.g., Nafion®) in a solvent. A catalyst of the present disclosure can include one or more metals such as platinum (Pt), palladium (Pd), molybdenum (Mo), cobalt (Co), ruthenium (Ru), nickel (Ni), tin (Sn), and combinations thereof.

The ionomer is typically purchased as a solution in a solvent of choice and at the desired initial concentration, and additional solvent is added to adjust the ionomer concentration to a desired concentration in the ink formulation. The ink formulation may contain polytetrafluoroethylene. The catalyst, catalyst support (e.g., a carbon support), or catalyst composition may be dispersed in the ink formulation by techniques such as ultra-sonication or ball-milling. The ink formulation may include one or more agglomerates having an average agglomerate size in the range of about 50 nm to about 500 nm, such as about 100 nm to about 400 nm, such as about 200 nm to about 300 nm.

The catalyst composition may make up about 1 wt % to about 20 wt % of the ink formulation, such as about 2.5 wt % to about 10 wt %, such as about 3 wt % to about 7 wt %. The ionomer may make up about 1 wt % to about 30 wt % of the ink formulation, such as about 5 wt % to about 25 wt %, such as about 10 wt % to about 20 wt %. The solvent may make up about 80 wt % or more of the ink formulation, such as about 85 wt % or more, such as about 90 wt % or more. The solvent used in the ink formulation may include a mixture of a non-water solvent (e.g., isopropanol (IPA)) and water at a weight ratio of about 5:1 to about 1:5 (non-water:water), such as about 3:1 to about 1:3, such as about 2:1 to about 1:2, such as about 1:1. The ionomer and catalyst may be present in the ink formulation at a weight ratio of about 3:1 to about 1:3 (ionomer:catalyst), such as about 2:1 to about 1:2, such as about 1:0.85 to about 0.85:1, such as about 1:0.85. The ink formulation may include the carbon support and solvent in a weight ratio of about 1:0.01 to about 0.01:1 (carbon:solvent), such as about 1:0.02 to about 0.02:1, such as about 1:0.03 to about 0.03:1, such as about 1:0.03.

The weight ratio of solids to liquids within the ink formulation may be in the range of about 5:1 to about 1:5 (solids:liquids), such as about 3:1 to about 1:3, such as about 2:1 to about 1:2. The ink formulation may be made up of about 1 wt % to about 30 wt % solids, such as about 5 wt % to about 25 wt %, such as about 10 wt % to about 15 wt %.

The non-water solvent used in the ink formulation may include a “low boiling point solvent” and/or a “high boiling point solvent”. As used herein, low boiling point solvents typically have a boiling point below about 100° C. at atmospheric pressure (e.g. 25-30° C.) and high boiling point solvents have a boiling point above about 100° C. or greater (e.g., 100-200° C.). The non-water solvent used in the ink formulation may include isopropanol, propanol, ethanol, methanol, n-butanol, 2-pentanol, 2-octanol, butyl acetate, and mixtures thereof.

At operation 120 of the method 100, the ink formulation is deposited onto a substrate to prepare a coated substrate. The substrate may be selected from either a porous substrate or a non-porous substrate. If a porous substrate is employed, often the solvent and ionomer in the ink formulation is absorbed into the pores of the substrate. Such absorption results in an overall loss of ionomer from the decal. As recognized by one of skill in the art, when using a porous substrate material there is always some loss of the ink formulation into the pores, typically in the range of about 15% to about 25%. Thus, a porous substrate may absorb and remove the ink formulation in unpredictable amount. Therefore, modification of the ink formulation to optimize performance characteristics is more easily achieved when using non-porous substrates, because of minimization of material loss and more predictable and reproducible results. Often, to compensate for the ionomer loss when using a porous substrate, an additional layer of ionomer is sprayed onto the decal after drying, to compensate for lost ionomer. The added ionomer layer is pressed into the decal during hot pressing, and compensates for the ionomer loss. As discussed, non-porous substrate materials according to the present invention substantially eliminate the loss of ionomer via absorption into the substrate, thus substantially eliminating the need to add additional ionomer layers. The present invention may provide more cost effective processing, by preventing loss of ionomer and additional processing steps. As appreciated by one of skill in the art, a non-porous polymeric substrate has a negligible porosity that is substantially free of pores, and thus minimal ionomer loss.

The substrate may exhibit one or more material properties, such as chemical resistance, a minimum temperature resistance of at least about 160° C., and/or a surface energy of about 5 dynes/cm to about 55 dynes/cm, such as about 10 dynes/cm to about 50 dynes/cm, such as about 15 dynes/cm to about 45 dynes/cm, such as about 18 dynes/cm to about 41 dynes/cm. A surface energy value that is too high may prohibit or interfere with transfer of the catalyst film to the membrane, as where one that is too low results in a poor coating on the substrate. The thickness of the substrate may be between about 12 μm to about 250 μm, such as about 20 μm to about 200 μm, such as about 50 μm to about 100 μm. The substrate may be composed of thermoplastic polymers such as, polyimide, polyphenylsulfone, and polytetrafluoroethylene (PTFE), and/or ethylene tetrafluoroethylene (ETFE).

As previously discussed, operation 120 of the method 100 involves disposing the ink formulation onto a surface of the substrate. Operation 120 may include disposing the ink formulation onto a discrete region of a surface of the substrate in one or more layers, and drying the ink formulation such that the solvent is substantially removed to form coated ink formulation with a preselected concentration of catalyst. The ink formulation may be deposited onto the substrate by any suitable coating technique, such as screen-printing or rod-coating (e.g., Mayer-rod coating). The ink formulation may be dried via vaporization of the solvent from the deposited ink formulation. The coated ink formulation may have a thickness ranging from about 3 μm to about 25 μm, such as about 5 μm to about 20 μm, such as about 10 μm to about 15 μm. The ink formulation may be dried at a temperature of about 25° C. to about 100° C., such as about 40° C. to about 80° C., such as about 50° C. to about 60° C. The ink formulation may be dried under vacuum, with or without the application of heat. Such methods of drying are well known in the art, and may include heat application by oven or infrared lamps.

In operation 130 of the method 100, the coated ink formulation and underlying substrate are die cut to form a decal. The decal may be cut in any suitable shape or size adequate for subsequent processing operations. In operation 140 of the method 100, the decal is bonded to a membrane (e.g., an ionically-conductive proton exchange membrane) by hot-pressing at or above the glass transition temperature for the ionomer under elevated pressures, but below the glass transition temperature of the substrate, to form a coated catalyst membrane (CCM). The CCM may be formed by hot pressing a decal to a membrane at a temperature of about 110° C. to about 145° C. and a pressure of about 250 psi to about 350 psi for about 1 min to about 10 min. The substrate may be removed from the CCM subsequently after the hot-press process. It should be noted that the CCM includes the coated ink formulation only on one surface of the membrane, wherein the opposite surface is blank.

The coated ink formulation of the CCM can act as an anode component. The anode component may have a platinum loading in a range from about 0.05 mg/cm² to about 0.4 mg/cm², such as about 0.1 mg/cm² to about 0.3 mg/cm², such as about 0.15 mg/cm² to about 0.25 mg/cm². The anode component may have a thickness in a range of about 5 μm to about 20 μm, such as about 8 μm to about 17 μm, such as about 10 μm to about 15 μm.

At operation 150 of the method 100, an spray coating ink formulation is prepared. The catalyst composition (as described above) may make up about 0.01 wt % to about 10 wt % of the spray coating ink formulation, such as about 0.05 wt % to about 5 wt %, such as about 0.1 wt % to about 1 wt %. The ionomer (as described above) may make up about 0.1 wt % to about 20 wt % of the spray coating ink formulation, such as about 0.5 wt % to about 10 wt %, such as about 1 wt % to about 5 wt %. The solvent (as described above) may make up about 85 wt % or more of the ink formulation, such as about 90 wt % or more, such as about 95 wt % or more, such as about 99 wt % or more. The solvent used in the ink formulation may include a mixture of IPA and water at a weight ratio of about 5:1 to about 1:5 (non-water:water), such as about 3:1 to about 1:3, such as about 2:1 to about 1:2, such as about 1:1. The ionomer and catalyst may be present in the spray coating ink formulation at a weight ratio of about 3:1 to about 1:3 (ionomer:catalyst), such as about 2:1 to about 1:2, such as about 1:0.85 to about 0.85:1, such as about 1:0.85. The spray coating ink formulation may include the carbon support and solvent in a weight ratio of about 1:10 (carbon:solvent) or greater, such as about 1:50 or greater, such as about 1:100 or greater.

The weight ratio of solids to liquids within the spray coating ink formulation may be in a range of about 1:10 (solids:liquids) or greater, such as about 1:25 or greater, such as about 1:50 to about 1:100. The spray coating ink formulation is made up of about 0.1 wt % to about 20 wt % solids, such as about 0.5 wt % to about 10 wt %, such as about 1 wt % to about 5 wt %.

At operation 160 of the method 100, the spray coating ink formulation is applied to the blank side of the membrane of the CCM to form a membrane electrode assembly (MEA) via a spray coating process, such as ultrasonic spraying or air spraying. As such, the spray coating ink formulation may be fed to a spray coating apparatus at an ink feed rate in a range from about 0.25 mL/min to about 0.35 mL/min, such as about 0.28 mL/min to about 0.33 mL/min, such as about 0.3 mL/min. The spray coating apparatus may include an ultrasonic spray coater equipped with a pressurized gas source to eject the spray coating ink formulation form the spray coating apparatus and onto the blank side of the membrane of the CCM. The pressurized carrier gas source may provide a carrier gas pressure in a range from about 0.6 pounds per square inch (psi) to about 0.8 psi, such as about 0.65 psi to about 0.75 psi, such as about 0.7 psi. The ultrasonic spray coater may be operated at a vibration power of about 1 W to about 5 W, such as about 2 W to about 4 W, such as about 3 W. The spray coating process of operation 160 may incorporate the use of a vacuum heating plate such that the solvent of the spray coating ink formulation may be removed simultaneously with the deposition of the spray coating ink formulation. In such instances, operation 160 may be conducted under vacuum at a temperature of about 50° C. to about 80° C., such as about 55° C. to about 75° C., such as about 60° C. to about 70° C. Once dried, the spray coating of the MEA can act as a cathode component. The cathode component may have a platinum loading in a range from about 0.1 mg/cm² to about 0.4 mg/cm², such as about 0.15 mg/cm² to about 0.35 mg/cm², such as about 0.2 mg/cm² to about 0.3 mg/cm². The cathode component may have a thickness in a range of about 10 μm to about 30 μm, such as about 15 μm to about 25 μm, such as about 20 μm.

MEAs of the present disclosure may have a crossover current of about 0.9 mA/cm² or less, as determined by cyclic voltammetry, such as about 0.8 mA/cm² or less, such as about 0.7 mA/cm² or less. MEAs of the present disclosure may have a electrochemical surface area (ECSA) in a range from about 20 m²/g_{(Pt)} to about 60 m²/g_{(Pt)}, as determined by cyclic voltammetry, such as about 30 m²/g_{(Pt)} to about 50 m²/g_{(Pt)}, such as about 35 m²/g_{(Pt)} to about 45 m²/g_{(Pt)}. MEAs of the present disclosure may have a mass activity in a range from about 0.2 A/mg_{(Pt)} to about 0.6 A/mg_{(Pt)}, as determined by the current at 0.9 V when flowing H₂ to the anode and O₂ to the cathode and corresponding Pt loading in the cathode, such as about 0.3 A/mg_{(Pt)} to about 0.5 A/mg_{(Pt)}, such as about 0.35 A/mg_{(Pt)} to about 0.45 A/mg_{(Pt)}. MEAs of the present disclosure may have a specific activity in a range from about 400 μA/cm²_{(Pt)} to about 1100 μA/cm²_{(Pt)}, as determined by dividing the mass activity by the ECSA, such as about 600 μA/cm²_{(Pt)} to about 900 μA/cm²_{(Pt)}, such as about 700 μA/cm²_{(Pt)} to about 800 μA/cm²_{(Pt)}. MEAs of the present disclosure may have an open circuit voltage (OCV) in a range from about 0.984 V to about 0.997 V, as determined during a Break-in process, such as about 0.99 V. MEAs of the present disclosure may have an OCV in a range from about 0.979 V to about 1.001 V, as determined during 60% relative humidity polarization, such as about 0.985 V to about 0.995 V. MEAs of the present disclosure may have an OCV in a range from about 0.997 V to about 1.012 V, as determined during 100% relative humidity polarization.

### EXAMPLES

### Materials

Commercial Pt/C catalyst (e.g., a catalyst composition), TEC10E50E catalyst (denoted as TKK50 below), is used as purchased having a Pt content of about 47 wt %. D2020 solution from Ion Power Inc. is used as the ionomer solution. Isopropyl alcohol (IPA; 99.5%, Sigma-Aldrich, St. Louis, MO, USA) and DI water are used as the solvent. NR211 from Ion Power USA is used for the membrane in all prepared MEA samples.

### Ink Preparation and Catalyst Film Preparation

Ink formulations were prepared based on three parameters including I/C ratio, Carbon/solvent ratio, IPA/water ratio to define an ink (all ratios are by weight). If all of these three parameters are the same between two inks, the two inks are considered to be the same. Depending on the catalyst film fabrication method, two types of ink with different carbon/solvent ratio are prepared, while I/C ratio of 0.85 and IPA/water ratio of 1 were kept the same. Ink formulations deposited via a rod coating method used a thick slurry ink having a carbon/solvent weight ratio of about 0.03. Ink formulations deposited via a spray coating method used a diluted ink slurry with carbon/solvent weight ratio of about 0.00424.

An exemplary rod coating ink formulation was prepared by adding 0.2 g of TEC10E50E Pt/C catalyst (50 wt %, TKK, Japan), 0.4504 g Nafion D2020 (Dupont, USA), and 1.6126 g of water and 1.5599 g and mixing using a Thinky Mixer. An exemplary rod coating process can include uniformly disposing the rod coating ink formulation on a 4 mill virgin PTFE substrate using Number 32 meyer rod. The catalyst film on PTFE was cut to a specific size to form a decal, which will be used under hot press to form either MEA or half catalyst coated membrane (CCM), which means only one side has catalyst layer, the other side is left blank.

An exemplary spray coating ink formulation was prepared using 0.16 g of TEC10E50E Pt/C catalyst, 0.3604 g Nafion D2020, and 9.8773 g of water and 9.8344 g of IPA were added into a 30 mL vial and sonicated for 30 min followed by using a homogenizer under 18 W for 2 min. The spraying coating is conducted using an ultrasonic spray coater (Sono-Tek, USA) with AccuMist nozzle. During the spraying process, the membrane was firmly placed on a vacuum plate at 60° C.-80° C. and the membrane was covered by a piece of mask with 3 cm×4 cm size hole in the middle. The air pressure of 0.60-0.80 psi and the vibration power of 2.5 W were used simultaneously with the ink feeding rate between 0.25-0.35 mL/min.

Three different MEA samples were prepared, and are differentiated by the method in which each of the respective anode and cathode components are prepared on the membrane. In sample 1, both the anode and cathode components are deposited via a rod coating process. In sample 2, each of the anode and cathode components are deposited via a spray coating process. In sample 3, the anode component is prepared using a rod coating process and the cathode component is prepared using a spray coating process. The MEAs are dried sufficiently at room temperature, and their respective anode Pt loading, cathode Pt loading, and MEA active areas are summarized in Table 1. The analysis of each of the samples is described below.

TABLE 1
Summary of MEA samples and Pt loading thereof.

| | | Anode Pt | | Cathode Pt | |
|---|---|---|---|---|---|
| | Anode | Loading | Cathode | Loading | MEA Active |
| Sample | Fabrication | (mg/cm²) | Fabrication | (mg/cm²) | Area (cm²) |
| 1 | Rod Coating | 0.24 | Rod Coating | 0.24 | 12 |
| 2 | Spray Coating | 0.16 | Spray Coating | 0.27 | 12 |
| 3 | Rod Coating | 0.2 | Spray Coating | 0.17 | 12 |

### Scanning Electron Microscopy

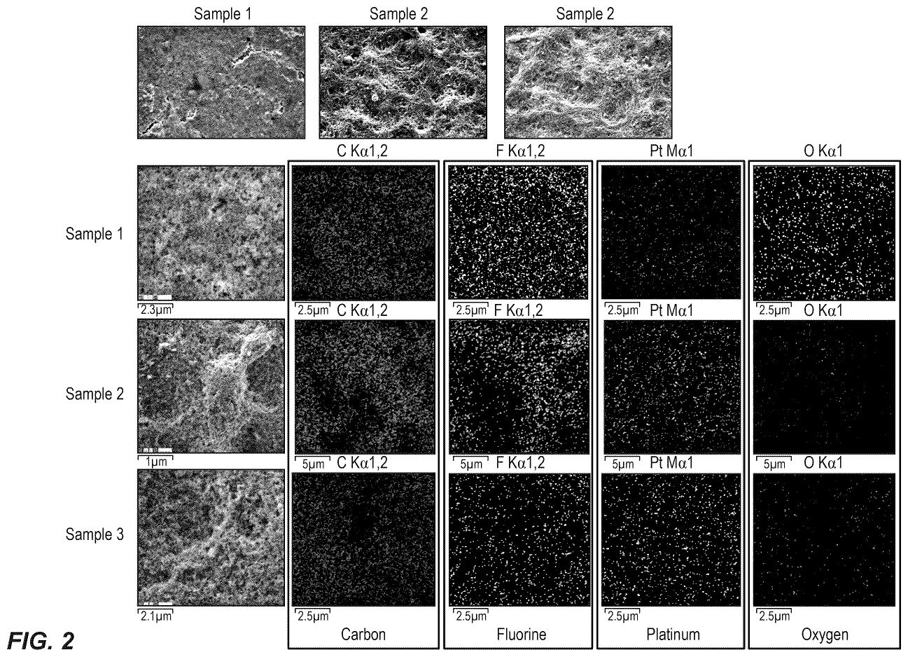

Scanning electron microscopy (SEM) is conducted using QUANTA FEG 650 instrument, 10 keV electron voltage. The morphology images were taken of each of the prepared MEAs cathode component. Additionally, each of the prepared MEAs underwent an elemental mapping analysis to determine surface composition of each sample, respectively. The SEM images are shown in FIG. 2 and the results from the elemental mapping are summarized in Table 2.

TABLE 2
Mass percentage of C, O, F, and Pt in each cathode component.

| Element | Sample 1 | Sample 2 | Sample 3 |
|---|---|---|---|
| C (wt %) | 47 | 47 | 48 |
| O (wt %) | 2.6 | 2.5 | 3.1 |
| F (wt %) | 10.5 | 8.8 | 9.2 |
| Pt (wt %) | 40 | 41 | 40 |

The catalyst film of sample 3 shows a porous surface. However, sample 2 shows a wave-like texture, which may relate to the ionomer distribution in the film. The wave top area is F rich according to the F mapping analysis of sample 2. The surface of sample 1 is relatively flat with some crackers in the film. The Pt percentage is similar in the cathode of three MEAs, which excludes out that the MEA performance difference is from the Pt content.

### Electrochemical Analysis

A custom-built test station, equipped with gas humidifiers to control cell humidity, mass flow controllers to regulate gas flow at pre-specified rates, electronic pressure regulators to control cell backpressure, a cell temperature controller to manage the flow field temperatures, and temperature and pressure sensors, was used to conduct the fuel cell experiments. Custom Python-written GUIs were employed to control all these devices. The Zahner Zenium Pro Potentiostat, coupled with the Zahner PP242 Booster Potentiostat, was used to control the DC load and provide AC perturbation for performing electrochemical impedance spectroscopy (EIS) to measure the high-frequency resistance (HFR).

Graphite flow field hardware from Baltic Fuel Cell GmbH, with an active area of 12 cm2, was utilized. Nafion NR211 membranes, purchased from Ion Power USA, were used to fabricate the in-house catalyst-coated membranes (CCMs). AvCarb GDS 2230 gas diffusion media (GDM) were employed on both the anode and cathode sides, and a compressive stress of 1.05 MPa was applied to the cell active area to optimize the performance of the GDM.

### Cyclic Voltammetry

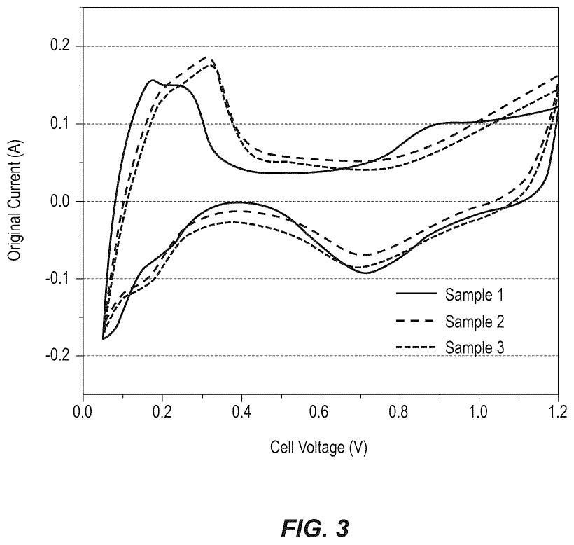

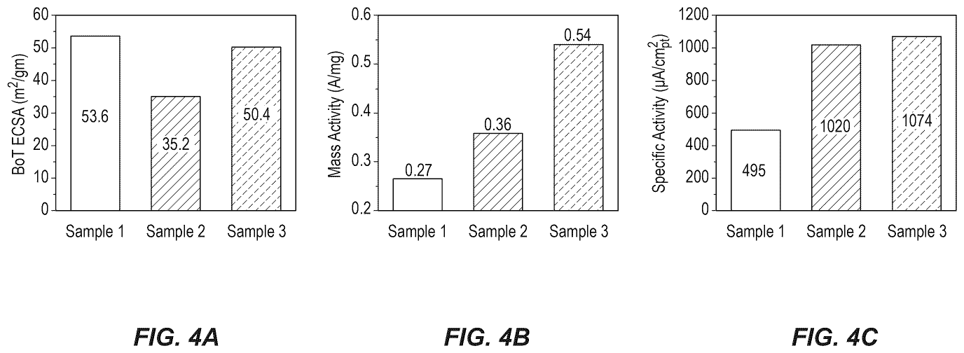

Cyclic voltammetry (CV) was performed to evaluate the electrochemically active surface area (ECSA) of the catalyst, measured in m²/g_{(Pt)}. The test was conducted at 30° C. under fully humidified conditions and ambient pressure. During the test, 100 sccm of H₂ and 250 sccm of N₂ were supplied to the anode and cathode, respectively. The cell was equilibrated for 30 minutes at open-circuit voltage (OCV) while maintaining gas flows and temperature. Subsequently, 10 CV cycles were performed at a scan rate of 10 mV/s over a potential range of 0.05 V to 1.2 V. The ECSA was calculated from the last cycle by integrating the hydrogen adsorption/desorption peaks (for platinum-based catalysts) using the known charge density of hydrogen, 210 μC/cm² for a monolayer. The obtained CV plots for each of the samples are shown in FIG. 3. Additionally, the resulting ECSA, mass activity, and specific activity of each of the samples are shown in FIG. 4A-4C, respectively. The mass activity is determined by the current at 0.9 V when flowing H₂ to the anode and O₂ to the cathode and corresponding Pt loading in the cathode.

All MEA shows a comparable ECSA with literature reported for TEC10E50E catalyst. Sample 3 shows the highest mass activity of 0.54 A/mg followed by sample 2 of 0.36 A/mg, and both MEA are higher than sample 1 of 0.26 A/mg. The spray coated cathode MEAs (samples 2 and 3) show more than doubled specific activity (>1000 μA/cm² Pt) than sample 1 of 495 μA/cm² Pt.

Cyclic voltammetry was also used to assess crossover and shorting currents in the PEMFC by analyzing specific features in the CV plot. These features provided insights into gas crossover and internal electrical shorts.

Hydrogen crossover (crossover current) occurs when unreacted hydrogen permeates from the anode to the cathode. At the cathode, the hydrogen is oxidized electrochemically, contributing to a measurable current. In the CV plot, this is observed as a baseline shift along the y-axis (current axis). In this study, the crossover current was quantified as the current offset (baseline shift) in the CV curve at a potential where no faradaic reactions, such as hydrogen oxidation or oxygen reduction, occurred.

Internal electronic shorts (shorting current) within the membrane occur due to pinholes, contaminants, or structural defects, creating pathways for direct electron conduction and leading to parasitic current flow. In the CV plot, these currents appear as a tilted baseline, deviating from the expected flat profile. This tilt occurs because the shorting current increases proportionally with the applied potential, resulting in a linear relationship. In this study, the shorting current was estimated by analyzing the slope of the CV baseline.

### Break-In Process

After CV, a break-in or activation process was performed to activate the catalyst layer, which helped create proton-conducting domains and enhance catalyst activity. The procedure involved flowing H₂ and air at the anode and cathode at flow rates of 800 and 2000 sccm, respectively. It was conducted under fully hydrated conditions at 80° C. and a backpressure of 150 kPaa. The 16-cycle break-in was performed by cycling the cell voltage between OCV, 0.40, 0.60, 0.70, and 0.85 V. The cell performance increased progressively with the number of cycles, demonstrating the necessity of the break-in procedure.

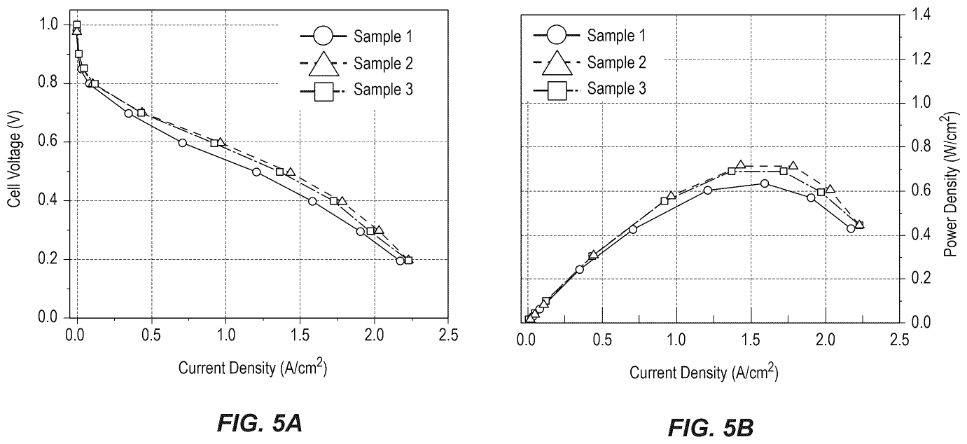

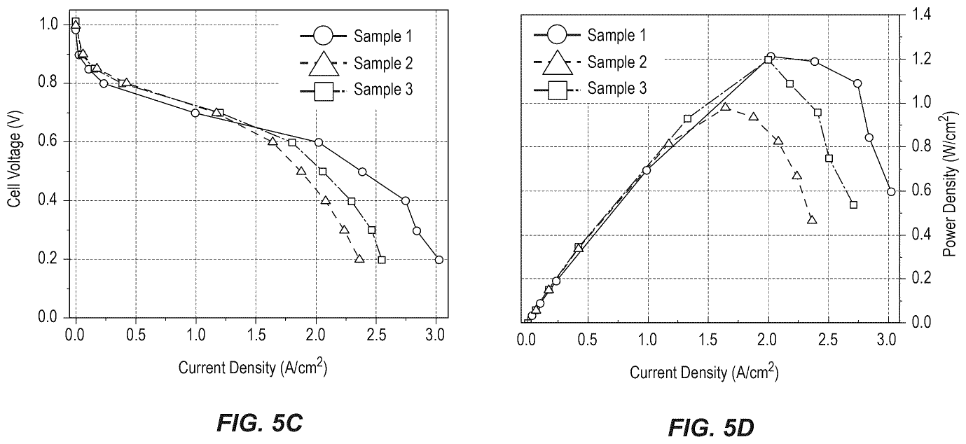

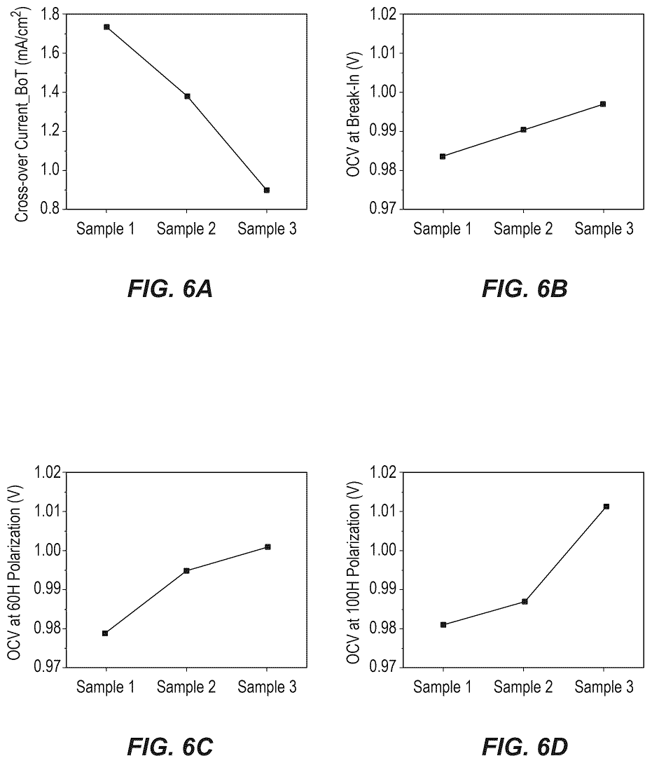

Steady-state fuel cell performance curves were collected by holding the cell voltage at each potential for 10 minutes and then averaging the last minute of the data. Performance was evaluated at voltages starting from OCV and then sequentially at 0.90, 0.85, 0.80, 0.70, 0.60, 0.50, 0.40, 0.30, and 0.20 V. Performance curves were recorded at dry (80° C., 60% relative humidity (RH), 100 kPaa.) and wet (80° C., 100% RH, 300 kPaa.) conditions at a H₂ and air flow of 500 and 2400 sccm at anode and cathode, respectively. The polarization curves of each of the samples at each of the above described conditions are shown in FIG. 5A-5D, respectively. Additionally, the cross-over current and OCV of each of the samples at various test conditions are shown in FIG. 6A-6D.

At 60% RH, comparing with sample 1, samples 2 and 3 show better performance in polarization curve and 11% higher in peak power density. At 100% RH, sample 2 and 3 show better performance in dry region (>0.7 V) and it becomes slightly worse than sample 1 in wet region (<0.7 V) indicating a better activation and Ohmic performance, but a worse mass transport in samples 2 and 3. However, sample 3 shows a same peak power density as sample 1. Overall, MEAs fabricated using a rod coated anode component and a spray coated cathode component (e.g., sample 3) perform better in dry condition and show a same peak power density of 1.2 W/cm² in wet condition (100% RH) when compared with MEAs formed with rod coated anodes and rod coated cathodes (e.g., sample 1).

MEAs fabricated using a rod coated anode component and a spray coated cathode component (e.g., sample 3) exhibit the lowest cross-over current of 0.9 mA/cm² among all three types, indicating the fabrication method used to prepare sample 3 is the best configuration for making a MEA. Furthermore, this is also confirmed by the highest OCV of 0.997 V during the Break in process, as indicated in FIG. 6B. Additionally, the OCV during 60% RH polarization (shown in FIG. 6C) and 100% RH polarization (shown in FIG. 6D) are over 1.0 V, which is beneficial from the low cross-over current of the MEA.

Overall, The present disclosure provides a method by which to prepare MEAs with enhance properties and/or performance. More specifically, the method disclosed herein utilizes a rod coating process to form an anode component of an MEA, and a spray coating process to form a cathode component of an MEA. Notably, MEAs fabricated using a rod coated anode component and a spray coated cathode component (e.g., sample 3) exhibit the least crossover current and the highest open circuit voltage (OCV) performance. Additionally, MEAs fabricated using a rod coated anode component and a spray coated cathode component (e.g., sample 3) demonstrate the higher mass activity than traditionally formed MEAs, and more than double the specific activity of MEAs formed with rod coated anodes and rod coated cathodes (e.g., sample 1). Thus, the fabrication method disclosed herein can be effectively applied to various other materials, in addition to commercial catalysts, to achieve significant improvements in MEA performance.

### Aspects Listing

The present disclosure provides, among others, the following aspects, each of which may be considered as optionally including any alternate aspects:

Aspect 1. A method for preparing a membrane electrode assembly (MEA), the method comprising:
depositing, by a rod coating process, a first ink composition onto a first surface of a substrate;
heat treating the substrate to convert the first ink composition to an anode component;
depositing, by a spray coating process, a second ink composition onto a second surface of the substrate opposite the first surface to form a MEA; and
drying the MEA, wherein the second ink composition is converted to a cathode component.

Aspect 2. The method of aspect 1, wherein the first ink composition, the second ink composition, or both comprise a platinum-based catalyst.

Aspect 3. The method of any aspects 1-2, wherein the anode component comprises a platinum loading in a range from about 0.05 mg/cm² to about 0.4 mg/cm².

Aspect 4. The method of any aspects 1-3, wherein the cathode component comprises a platinum loading in a range from about 0.1 mg/cm² to about 0.4 mg/cm².

Aspect 5. The method of any aspects 1-4, wherein the heat treating the substrate comprises heat pressing substrate at a temperature in a range from about 110° C. to about 145° C. for about 1 min to about 10 min.

Aspect 6. The method of any aspects 1-5, wherein the spray coating process comprises:
introducing the second ink composition to a spray coating apparatus at an ink feed rate in a range from about 0.2 mL/min to about 0.35 mL/min, the spray coating apparatus equipped with a pressurized carrier gas source to eject the second ink composition from the spray coating apparatus and onto the second surface of the substrate, wherein the pressurized carrier gas source provides a carrier gas pressure in a range from about 0.6 pounds per square inch (psi) to about 0.8 psi.

Aspect 7. The method of any aspects 1-6, wherein the anode component has a thickness in a range from about 5 μm to about 20 μm.

Aspect 8. The method of any aspects 1-7, wherein the cathode component has a thickness in a range from about 10 μm to about 30 μm.

Aspect 9. A membrane electrode assembly (MEA), comprising:
an anode component disposed on a first surface of a substrate, the anode component having a thickness in a range from about 5 μm to about 20 μm and a platinum loading in a range from about 0.05 mg/cm² to about 0.4 mg/cm²; and
a cathode component disposed on a second surface of the substrate opposite the first surface of the substrate, the cathode component having a thickness in a range from about 10 μm to about 30 μm and a platinum loading in a range from about 0.1 mg/cm² to about 0.4 mg/cm², the MEA having a cross-over current of about 0.9 mA/cm² or less, as determined by cyclic voltammetry.

Aspect 10. The MEA of aspect 9, wherein the MEA comprises an electrochemical surface area (ECSA) in a range from about 20 m²/g_{(Pt)} to about 60 m²/g_{(Pt)}, as determined by cyclic voltammetry.

Aspect 11. The MEA of aspects 9-10, wherein the MEA has a mass activity in a range from about 0.2 A/mg_{(Pt)} to about 0.6 A/mg_{(Pt)}, as determined by the current at 0.9 V when flowing H₂ to the anode and O₂ to the cathode and corresponding Pt loading in the cathode.

Aspect 12. The MEA of aspects 9-11, wherein the MEA has a specific activity in a range from about 400 μA/cm²_{(Pt)} to about 1100 μA/cm²_{(Pt)}, as determined by dividing the mass activity by the ECSA.

Aspect 13. A method for preparing a membrane electrode assembly (MEA), the method comprising:
depositing, by a rod coating process, a first ink composition onto a first surface of a substrate;
heat treating the substrate to convert the first ink composition to an anode component;
depositing, by a spray coating process, a second ink composition onto a second surface of the substrate opposite the first surface to form a MEA; and
drying the MEA to convert the second ink composition to a cathode component, and wherein the MEA has a cross-over current of about 0.9 mA/cm² or less, as determined by cyclic voltammetry.

Aspect 14. The method of aspect 13, wherein the anode component comprises a platinum loading in a range from about 0.05 mg/cm² to about 0.4 mg/cm².

Aspect 15. The method of any aspects 13-14, wherein the cathode component comprises a platinum loading in a range from 0.1 mg/cm² to about 0.4 mg/cm².

Aspect 16. The method of aspects 13-15, wherein the MEA comprises a electrochemical surface area (ECSA) in a range from about 20 m²/g_{(Pt)} to about 60 m²/g_{(Pt)}, as determined by cyclic voltammetry.

Aspect 17. The method of aspects 13-16, wherein the MEA has a mass activity in a range from about 0.2 A/mg_{(Pt)} to about 0.6 A/mg_{(Pt)}, as determined by the current at 0.9 V when flowing H₂ to the anode and O₂ to the cathode and corresponding Pt loading in the cathode.

Aspect 18. The method of aspects 13-17, wherein the MEA has a specific activity in a range from about 400 μA/cm²_{(Pt)} to about 1100 μA/cm²_{(Pt)}, as determined by dividing the mass activity by the ECSA.

Aspect 19. The method of aspects 13-18, wherein the MEA has an open circuit voltage (OCV) in a range from about 0.984 V to about 0.997 V, as determined during a Break-in process.

Aspect 20. The method of aspects 13-19, wherein the MEA has an open circuit voltage (OCV) in a range from about 0.979 V to about 1.001 V, as determined during 60% relative humidity polarization.

Aspect 21. The method of aspects 13-20, wherein the MEA has an open circuit voltage (OCV) in a range from about 0.997 V to about 1.012 V, as determined during 100% relative humidity polarization.

As is apparent from the foregoing general description and the specific aspects, while forms of the aspects have been illustrated and described, various modifications may be made without departing from the spirit and scope of the present disclosure. Accordingly, it is not intended that the present disclosure be limited thereby. Likewise, the term “comprising” is considered synonymous with the term “including.” Likewise whenever a composition, an element, a group of elements, or a method is preceded with the transitional phrase “comprising,” it is understood that we also contemplate the same composition, method, or group of elements with transitional phrases “consisting essentially of,” “consisting of,” “selected from the group of consisting of,” or “Is” preceding the recitation of the composition, element, elements, or method, and vice versa, such as the terms “comprising,” “consisting essentially of,” “consisting of” also include the product of the combinations of elements listed after the term.

For purposes of this present disclosure, and unless otherwise specified, all numerical values within the detailed description and the claims herein are modified by “about” or “approximately” the indicated value, and consider experimental error and variations that would be expected by a person having ordinary skill in the art. For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited. For example, the recitation of the numerical range 1 to 5 includes the subranges 1 to 4, 1.5 to 4.5, 1 to 2, among other subranges. As another example, the recitation of the numerical ranges 1 to 5, such as 2 to 4, includes the subranges 1 to 4 and 2 to 5, among other subranges. Additionally, within a range includes every point or individual value between its end points even though not explicitly recited. For example, the recitation of the numerical range 1 to 5 includes the numbers 1, 1.5, 2, 2.75, 3, 3.80, 4, 5, among other numbers. Thus, every point or individual value may serve as its own lower or upper limit combined with any other point or individual value or any other lower or upper limit, to recite a range not explicitly recited.

As used herein, the indefinite article “a” or “an” shall mean “at least one” unless specified to the contrary or the context clearly indicates otherwise. For example, aspects comprising “a metal” include aspects comprising one, two, or more metals, unless specified to the contrary or the context clearly indicates only one metal is included.

While the foregoing is directed to aspects of the present disclosure, other and further aspects of the disclosure may be devised without departing from the basic scope thereof, and the scope thereof is determined by the claims that follow.

What is claimed is:

1. A method for preparing a membrane electrode assembly (MEA), the method comprising:
depositing, by a rod coating process, a first ink composition onto a first surface of a substrate;
heat treating the substrate to convert the first ink composition to an anode component;
depositing, by a spray coating process, a second ink composition onto a second surface of the substrate opposite the first surface to form a MEA; and
drying the MEA, wherein the second ink composition is converted to a cathode component.

2. The method of claim 1, wherein the first ink composition, the second ink composition, or both comprise a platinum-based catalyst.

3. The method of claim 1, wherein the anode component comprises a platinum loading in a range from about 0.05 mg/cm² to about 0.4 mg/cm².

4. The method of claim 1, wherein the cathode component comprises a platinum loading in a range from about 0.1 mg/cm² to about 0.4 mg/cm².

5. The method of claim 1, wherein the heat treating the substrate comprises heat pressing substrate at a temperature in a range from about 110° C. to about 145° C. for about 1 min to about 10 min.

6. The method of claim 1, wherein the spray coating process comprises:
introducing the second ink composition to a spray coating apparatus at an ink feed rate in a range from about 0.2 mL/min to about 0.35 mL/min, the spray coating apparatus equipped with a pressurized carrier gas source to eject the second ink composition from the spray coating apparatus and onto the second surface of the substrate, wherein the pressurized carrier gas source provides a carrier gas pressure in a range from about 0.6 pounds per square inch (psi) to about 0.8 psi.

7. The method of claim 1, wherein the anode component has a thickness in a range from about 5 μm to about 20 μm.

8. The method of claim 1, wherein the cathode component has a thickness in a range from about 10 μm to about 30 μm.

9. A membrane electrode assembly (MEA), comprising:
an anode component disposed on a first surface of a substrate, the anode component having a thickness in a range from about 5 μm to about 20 μm and a platinum loading in a range from about 0.05 mg/cm² to about 0.4 mg/cm²; and
a cathode component disposed on a second surface of the substrate opposite the first surface of the substrate, the cathode component having a thickness in a range from about 10 μm to about 30 μm and a platinum loading in a range from about 0.1 mg/cm² to about 0.4 mg/cm², the MEA having a cross-over current of about 0.9 mA/cm² or less, as determined by cyclic voltammetry.

10. The MEA of claim 9, wherein the MEA comprises an electrochemical surface area (ECSA) in a range from about 20 m²/g_{(Pt)} to about 60 m²/g_{(Pt)}, as determined by cyclic voltammetry.

11. The MEA of claim 9, wherein the MEA has a mass activity in a range from about 0.2 A/mg_{(Pt)} to about 0.6 A/mg_{(Pt)}, as determined by the current at 0.9 V when flowing H₂ to the anode and O₂ to the cathode and corresponding Pt loading in the cathode.

12. The MEA of claim 9, wherein the MEA has a specific activity in a range from about 400 μA/cm²_{(Pt)} to about 1100 μA/cm²_{(Pt)}, as determined by dividing the mass activity by the ECSA.

13. A method for preparing a membrane electrode assembly (MEA), the method comprising:
depositing, by a rod coating process, a first ink composition onto a first surface of a substrate;
heat treating the substrate to convert the first ink composition to an anode component;
depositing, by a spray coating process, a second ink composition onto a second surface of the substrate opposite the first surface to form a MEA; and
drying the MEA to convert the second ink composition to a cathode component, and wherein the MEA has a cross-over current of about 0.9 mA/cm² or less, as determined by cyclic voltammetry.

14. The method of claim 13, wherein the anode component comprises a platinum loading in a range from about 0.05 mg/cm² to about 0.4 mg/cm².

15. The method of claim 13, wherein the cathode component comprises a platinum loading in a range from 0.1 mg/cm² to about 0.4 mg/cm².

16. The method of claim 13, wherein the MEA comprises a electrochemical surface area (ECSA) in a range from about 20 m²/g_{(Pt)} to about 60 m²/g_{(Pt)}, as determined by cyclic voltammetry.

17. The method of claim 13, wherein the MEA has a mass activity in a range from about 0.2 A/mg_{(Pt)} to about 0.6 A/mg_{(Pt)}, as determined by the current at 0.9 V when flowing H₂ to the anode and O₂ to the cathode and corresponding Pt loading in the cathode.

18. The method of claim 13, wherein the MEA has a specific activity in a range from about 400 μA/cm²_{(Pt)} to about 1100 μA/cm²_{(Pt)}, as determined by dividing the mass activity by the ECSA.

19. The method of claim 13, wherein the MEA has an open circuit voltage (OCV) in a range from about 0.984 V to about 0.997 V, as determined during a Break-in process.

20. The method of claim 13, wherein:
the MEA has an open circuit voltage (OCV) in a range from about 0.979 V to about 1.001 V, as determined during 60% relative humidity polarization;
the MEA has an open circuit voltage (OCV) in a range from about 0.997 V to about 1.012 V, as determined during 100% relative humidity polarization; or
a combination thereof.
